(19) United States
(12) Patent Application Publication
(10) Pub. No.: US 2020/0311613 A1
(43) Pub. Date: Oct. 1, 2020

(54) CONNECTING MACHINE LEARNING METHODS THROUGH TRAINABLE TENSOR TRANSFORMERS

(71) Applicant: Microsoft Technology Licensing, LLC, Redmond, WA (US)

(72) Inventors: Yiming Ma, Menlo Park, CA (US); Jun Jia, Sunnyvale, CA (US); Yi Wu, Sunnyvale, CA (US); Xuhong Zhang, Sunnyvale, CA (US); Leon Gao, San Mateo, CA (US); Baolei Li, Santa Clara, CA (US); Bee-Chung Chen, San Jose, CA (US); Bo Long, Palo Alto, CA (US)

(21) Appl. No.: 16/370,156

(22) Filed: Mar. 29, 2019

(51) Int. Cl. G06N 20/20; G06N 5/04

(52) U.S. Cl. CPC G06N 20/20; G06N 5/04

(57) ABSTRACT

Herein are techniques for configuring, integrating, and operating trainable tensor transformers that each encapsulate an ensemble of trainable machine learning (ML) models. In an embodiment, a computer-implemented trainable tensor transformer uses underlying ML models and additional mechanisms to assemble and convert data tensors as needed to generate output records based on input records and inferencing. The transformer processes each input record as follows. Input tensors of the input record are converted into converted tensors. Each converted tensor represents a respective feature of many features that are capable of being processed by the underlying trainable models. The trainable models are applied to respective subsets of converted tensors to generate an inference for the input record. The inference is converted into a prediction tensor. The prediction tensor and input tensors are stored as output tensors of a respective output record for the input record.

### TECHNICAL FIELD

The present disclosure relates to ensemble learning for machine learning (ML) models and more particularly to technologies for ensemble encapsulation and composability of multiple ensembles.

### BACKGROUND

A machine learning (ML) model may be a summarization or generalization of domain data in a condensed form that can be used for classification, fitting, and other recognition or regression activities. A trainable ML model is trained by a computer program that (e.g. iteratively) refines (e.g. numerically adjusts) the model to increase the model's accuracy. For example, with supervised training, reinforcement learning may occur by applying a trainable model to training records and adjusting the model based on error (i.e. inaccuracy) of the model's response to each training record.

Training is a statistical method that needs many training records, which consumes much processing time and may be somewhat amenable to parallelization. As explained later herein, different kinds of trainable models may need different parallelization techniques. Thus, a training framework such as TensorFlow software library may not provide generalized parallelism to machine learning training.

Because training is statistical and data driven, some kinds of trainable models may sometimes be more accurate than others and other times be less accurate, depending on the input data. Thus, a diversity of models may be more accurate than a single model when there is a wide spectrum of varied input records. For example, models may be arranged into an ensemble to increase accuracy as discussed later herein. Various forms of heterogeneity between models, such as different algorithms and architectures or feature bagging as explained later herein, may require that different trainable models receive different input data and formats. Thus, there is a design tension between model diversity and data compatibility, which is not addressed by existing solutions. Therefore, there have been practical limits to aggregating models, such as into ensembles, and to composability of multiple ensembles into more general topologies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of an example trainable tensor transformer for encapsulating and operating an ensemble, in an embodiment;

FIG. 2 is a flow diagram of a process in which a trainable tensor transformer encapsulates and operates an ensemble, in an embodiment;

FIG. 3 is a block diagram of an example training configuration, in an embodiment;

FIG. 4 is a flow diagram of an example training process, in an embodiment;

FIG. 5 is a block diagram of an example transformer topology, in an embodiment;

FIG. 6 is a flow diagram of an example process for transformer cooperation, in an embodiment;

FIG. 7 is a block diagram of an example training topology, in an embodiment;

FIG. 8 is a flow diagram of an example process that uses one training corpus to train multiple transformers, in an embodiment;

FIG. 9 is a block diagram of an example transformer system for behavioral prediction, in an embodiment;

FIG. 10 is a flow diagram of an example prediction process, in an embodiment;

FIG. 11 is a block diagram that illustrates a hardware environment upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As explained above, trainable machine learning (ML) models may be arranged into an ensemble to increase accuracy. Ensemble operation requires that all of the underlying trainable models be unique in some way, such as by algorithm, architecture, or training. For example, trainable models may include an artificial neural network (ANN) such as a multilayer perceptron (MLP) for deep learning, a random forest, support vector machines (SVM), Bayesian networks, and other kinds of models. Various forms of heterogeneity between models, such as different algorithms and architectures or feature bagging as explained later herein, may require that different trainable models receive different input data and formats that impose practical limits upon aggregating models, such as into ensembles, and to composability of multiple ensembles into more general topologies.

Herein, a trainable tensor transformer encapsulates an ensemble of trainable ML models for new integration techniques for models and ensembles. Such transformers may be inserted into a data stream or other dataflow to process input records. Each transformer may augment the dataflow by adding an inference as a prediction tensor into an output record for downstream consumption, such as by another trainable tensor transformer. In that way, a transformer may provide data enrichment that may be more or less incomplete, such as when further processing downstream is needed, either for further enrichment or for final analytics. Thus, a logical topology may serially arrange multiple transformers in sequence to achieve a multistage dataflow pipeline, such that the output of an upstream transformer is delivered as input to a downstream transformer.

Likewise, multiple transformers may be arranged in parallel and may be supplied with duplicate forks of a same stream of input records. For example, two transformers may both be independently applied to separate copies of a same input record. Sibling transformers may be slightly redundant in function (although possibly containing models with very different algorithms, architectures, and/or prior training) to increase data integrity as discussed later herein. Transformers may also be arranged in parallel for functional decomposition. For example, inferences from sibling transformers may be more or less orthogonal to each other and not necessarily redundant.

A trainable tensor transformer may augment a data stream with predictions, classifications, or other inferences. Thus, a transformer may be used as an in-line (i.e. in-band) detector that may further be used for scoring, data skimming or stream filtration, anomaly/fraud detection, or facilitate other monitoring or analytics such as personalization, behavioral targeting, or matchmaking as described later herein.

A transformer may be applied to input data that is semantically rich and encoded as data tensors that operate as multidimensional arrays. A transformer may convert tensors from one format to another as needed by the transformer's underlying trainable models and/or by downstream consumers such as other transformers. For example, many data tensors may be flattened into a (e.g. very) wide one-dimensional feature vector (e.g. of numbers). Indeed, trainable tensor transformer techniques presented herein may achieve a feature vector that has much width without losing density (i.e. not sparse). A single input record bearing input tensors may deliver much information for sophisticated and accurate ML model inferencing. Thus, the quality and utility of inferences may be high.

Wide records means that a transformer may draw an inference not only from attributes of a single domain object, but also from a few or many domain objects, such as users, online artifacts, and interactions between them. With a statistical model, such as a variance components model, static objects such as users and artifacts may be so-called fixed (a.k.a. global) effects, and events may be so-called random effects. Thus, transformers may achieve a so-called mixed model that may predict multi-object behavior. In an embodiment, a system of transformer(s) may predict user behavior. Furthermore, behavioral predictions may reveal user preferences that may facilitate automation of recommendations, personalization, matchmaking, and advertisement targeting. Also presented herein are training techniques for trainable tensor transformer(s) such as bootstrap aggregating (bagging), sample bagging and folded cross validation, feature bagging, and hypothesis boosting that can avoid overfitting (i.e. memorizing common examples at the expense of reduced accuracy for uncommon ones). As described herein, transformer architecture can minimize how much time and space are spent preparing a feature vector of data tensors for each internal trainable model of a transformer. The performance benefit of such feature filtration may be substantial for feature bagging, which may ignore many or most features within any particular transformer. For example, with feature bagging, more sibling transformers may have smaller feature subsets per transformer, and thus achieve greater differentiation between transformers.

A technique that may work with some kinds of reinforcement learning algorithms, such as neural networks, is stochastic gradient descent (SGD) for parameter space (e.g. neural connection weights) exploration, such as implemented by TensorFlow for training. However, different kinds of trainable models may need different parallelization techniques that are incompatible with distributed SGD training, such as second-order optimization such as (e.g. quasi) Newton models, tree models, and other additive models such as a generalized additive model (GAM). For example as explained later herein, some trainable models may need access to an entire training corpus and should not be trained with small batches. Thus, a training framework such as TensorFlow software library may not provide generalized parallelism to machine learning training. Whereas, training techniques herein are parallelization agnostic.

Also as explained above, whether during or after training, there is a design tension between model diversity and data compatibility, which is not addressed by existing solutions. For example, the state of the art imposes practical limits to aggregating models, such as into ensembles, and to composability of multiple ensembles into more general topologies. Techniques herein configure and operate trainable tensor transformer(s) to achieve efficiencies at training and production inferencing with ensembles and underlying ML models that eluded the state of the art.

In an embodiment, a computer-implemented trainable tensor transformer uses underlying ML models and additional mechanisms to assemble and convert data tensors as needed to generate output records based on input records and inferencing. The transformer processes each input record as follows. Input tensors of the input record are converted into converted tensors. Each converted tensor represents a respective feature of many features that are capable of being processed by the underlying trainable models. The trainable models are applied to respective subsets of converted tensors to generate an inference for the input record. The inference is converted into a prediction tensor. The prediction tensor and input tensors are stored as output tensors of a respective output record for the input record.

Example Trainable Tensor Transformer

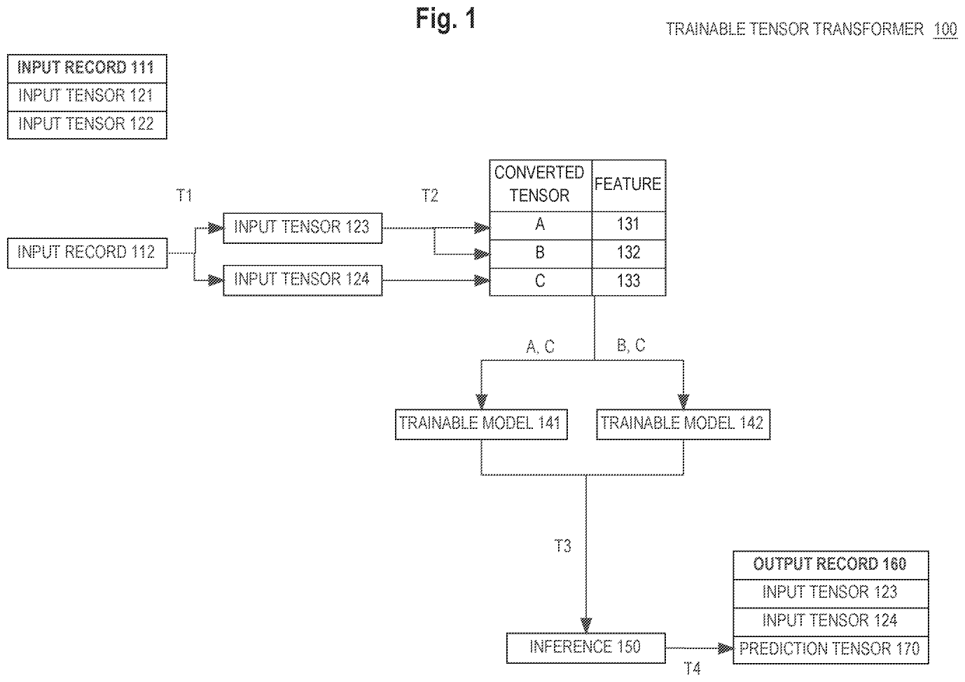

FIG. 1 is a block diagram that depicts an example trainable tensor transformer 100 for encapsulating and operating an ensemble, in an embodiment. Trainable tensor transformer 100 comprises a software system that may be hosted on one or more computers (not shown), such as a rack server such as a blade, a personal computer, a mainframe, or a virtual machine.

Trainable tensor transformer 100 encapsulates an ensemble of machine learning (ML) models, such as at least 141-142. Each of models 141-142 is distinct in algorithm, architecture, and/or configuration. For example, trainable model 141 may be an artificial neural network (ANN) such as a multilayer perceptron (MLP) for deep learning, and trainable model 142 may be a random forest. Other model algorithms include support vector machines (SVM) and Bayesian networks.

In another example, some or all of trainable models 141-142 involve a same ML algorithm, but have different architectures and/or hyperparameters. For example, somewhat similar perceptrons may have different counts of layers, neurons, and/or connections.

In another example and regardless of how similar or dissimilar are trainable models 141-142, differentiation of trainable models 141-142 arises from differences in training and especially in training data. For example and as discussed later herein, trainable tensor transformer 100 is amenable to training techniques such as bagging and boosting.

Training, as discussed later herein, is an operational mode or phase that need not occur in a production environment. In training, trainable models 141-142 are somewhat mutable. Whereas in the production environment, trainable tensor transformer 100 operates in its other mode, which is inferencing, during which trainable models 141-142 may be immutable.

Indeed, data structures that trainable tensor transformer 100 uses to represent trainable models 141-142 for training may be different from those of production. In an embodiment, trained configuration (e.g. learned connection weights of a neural network) of trainable models 141-142 may be persisted in a more or less dense format (e.g. multi-dimensional array of weight numbers, or compressed sparse row format, CSR) that is reloadable. Thus, trainable models 141-142 may be trained, persisted, and then reloaded in another environment for production use.

Training, as discussed later herein, entails mechanisms not needed in production. As shown, trainable tensor transformer 100 is configured for production inferencing, which operates as follows.

Whether arriving by stream or batch, trainable tensor transformer 100 transforms, one at a time, each of input records 111-112 into a new output record, such as 160. Tensor transformation entails a pipeline of processing stages, shown as T1-T4 that occur as follows.

At time T1, trainable tensor transformer 100 processes a next input record, such as 112, which may be a data structure such as in memory of a computer (not shown). Input records 111-112 may each represent a database record, such as a relational table row that represents an entity such as a piece of inventory. Input records 111-112 may each represent an event, such as a business transaction, a user interaction such as from a clickstream, or a log entry such as in a console log.

In an embodiment, input record 111 directly contains at least input tensors 121-122. Each of input tensors 121-122 may contain some data attribute(s) of input record 111. A tensor is a multi-dimensional aggregation of more or less homogenous (i.e. same data type) elements such as numbers. A zero-dimensional tensor is a scalar that has only one element.

In an embodiment, input record 112 does not directly contain input tensors. Instead, trainable tensor transformer 100 uses data fields (not shown) of input record 112 as lookup keys with which to retrieve input tensors 123-124 from other data sources such as memory caches, files, databases, and/or web services.

Regardless of how trainable tensor transformer 100 obtains input tensors 123-124, those tensors occur in a more or less native or natural format. Whereas, trainable models 141-142 expect input data to be available in a different format, such as a feature embedding, such as a feature vector. For example, the scale, dimensionality, schematic normalization, or encoding format of input data may need conversion. For example, input tensor 123 may need to be flattened into a lesser dimensionality, may need to be schematically denormalized, and/or may need to be split into multiple tensors or combined with other input tensors into a combined tensor.

Trainable tensor transformer 100 contains an input tensor converter (not shown) that, at time T2, converts input tensors 123-124 into converted tensors A-C. For example, converted tensors A-B are both generated from same input tensor 123.

What converted tensors should be generated depends on what feature inputs do trainable models 141-142 expect. In this example, at least features 131-133 are all (i.e. union) of the features needed by any of trainable models 141-142. In an embodiment, each of features 131-132 is associated with one or more of converted tensors A-C. In an embodiment, each of converted tensors A-C is associated with one or more of features 131-132. In the shown embodiment, there is a bijective (i.e. one to one) association between converted tensors and features.

In an embodiment, tensors 123-124 and A-C are implemented with TensorFlow and/or other software library(s) of data science mechanisms. In an embodiment, tensor conversion more or less entails a mix of library data manipulation and transformation mechanisms and custom logic.

Also at time T2, needed features 131-133 are supplied as converted tensors A-C to trainable models 141-142 as input data. Multiple converted tensors, such as B-C, may be supplied to a same trainable model, such as 142. A converted tensor, such as B, need not be supplied to some trainable models, such as 141.

A converted tensor, such as C, may be supplied to multiple trainable models, such as 141-142. Different trainable models, such as 141-142, may receive same data, such as input tensor 123, in alternate forms, such as converted tensors A-B that were both converted from same input tensor 123.

At time T3, trainable models 141-142 are applied to their respective input sets of converted tensors to generate inference 150. For example, trainable model 142 processes converted tensors B-C. Each of trainable models 141-142 generates inferential data at time T3. Inferential data may include predictions, regressions, classifications, and/or clustering. Inferential data may include (e.g. dense) data representations that originate within a trainable model, such as a features embedding, such as when trainable model 141 is an autoencoder.

Depending on the embodiment, trainable tensor transformer 100 may concatenate or mathematically combine inferential data (not shown) emitted by trainable models 141-142 into inference 150. For example, a soft max function may be applied to generate inference 150. Thus, inference 150 may contain a collective (e.g. average, mode, or quorum) prediction by the ensemble of trainable models 141-142 for input record 112. For example, input record 112 may be a pairing of a user and a search result, and inference 150 may be the ensemble's predicted probability that the user might actually select (e.g. click on) the search result.

In an embodiment, mere generation of inference 150 completes the processing of input record 112 by trainable tensor transformer 100. However, trainable tensor transformer 100 is designed for inclusion within a dataflow topology (not shown) that may include downstream processors such as other trainable tensor transformer(s). Thus at time T4, trainable tensor transformer 100 generates output record 160 to be recorded and/or sent downstream.

Output record 160 is a data structure, such as in memory, that is populated as follows. In an embodiment, input tensors 123-124 are copied (e.g. from input record 112) into output record 160. Trainable tensor transformer 100 also converts inference 150 into prediction tensor 170 that is stored into output record 160. Thus, trainable tensor transformer 100 may be inserted into a data stream in a more or less non-consumptive manner, such that stream data is preserved and propagated downstream as input tensors for additional processing.

Downstream (not shown), output record 160 may be received as an input record and processed, such as by another trainable tensor transformer. Downstream processors may use prediction tensor 170 as if it were another input tensor that supplements input tensors 123-124. Thus, trainable tensor transformer 100 may augment a data stream with predictions, classifications, or other inferences. Thus, trainable tensor transformer 100 may be used as an in-line (i.e. in-band) detector that may further be used for scoring, data skimming or stream filtration, anomaly/fraud detection, or facilitate other monitoring or analytics such as personalization, behavioral targeting, or matchmaking as described later herein.

Trainable Tensor Transformer Operating Process Overview

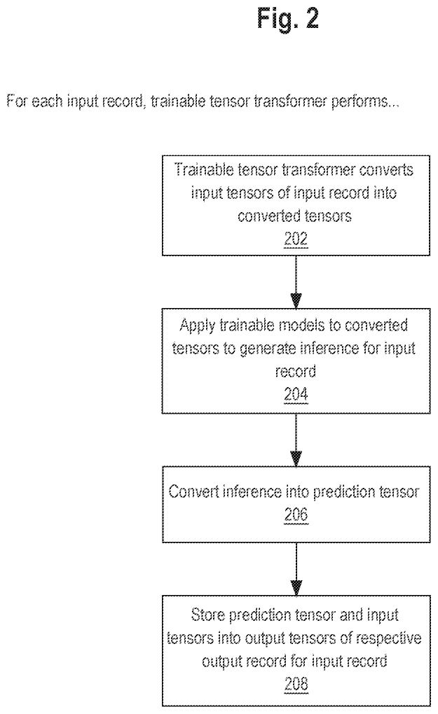

FIG. 2 is a flow diagram that depicts an example process in which a trainable tensor transformer encapsulates and operates an ensemble, in an embodiment. FIG. 2 is discussed with reference to FIG. 1.

As explained above, trainable tensor transformer 100 is configured for production inferencing, and trainable models 141-142 were already trained. Training techniques for trainable models and trainable tensor transformers are discussed later herein. One by one, from a stream or in batches, trainable tensor transformer 100 processes input records, such as 112. Step 202 extracts or obtains input tensors 123-124 directly from or indirectly through input record 112 at time T1.

For example, input record 112 may be implemented as a Spark DataFrame with PySpark that integrates Python and Apache Spark. Tensors 123-124 and A-C may be implemented with TensorFlow as Python objects. At time T2, trainable tensor transformer 100 converts input tensors 123-124 into converted tensors A-C to prepare feature data inputs for trainable models 141-142 as needed.

In an embodiment, trainable tensor transformer 100 has hand crafted logic, such as Python logic, that converts input tensors 123-124. The logic may be designed with knowledge of input tensors 123-124 and converted tensors A-C in mind. For example, a software developer may consider the dimensionality and element data type of each tensor and craft logic needed for data conversions based on an association between an input tensor and a converted tensor. In an embodiment not hand coded, trainable tensor transformer 100 instead has a data-driven tensor converter (not shown) that performs needed conversions by automatically interpreting and executing data binding metadata that declares a mapping between input tensors 123-124 and converted tensors A-C.

In step 204, trainable tensor transformer 100 applies trainable models 141-142 to needed subsets of converted tensors A-C to generate inference 150 for input record 112. For example, converted tensors A-C may be flattened (i.e. linearly serialized) and concatenated together to form a feature vector (not shown), which is a one dimensional vector of features, such as numeric values.

Each of trainable models 141-142 may have its own feature vector based on its own needed subset of features 131-133. Each of trainable models 141-142 processes its converted tensors as data inputs, either directly as tensors, or indirectly as a feature vector. At time T3, that processing generates inference 150 as a result, which may be synthesized as an integration of separate inferences (not shown) from each of trainable models 141-142. Inference 150 may comprise a data structure in memory.

In step 206 at time T4, trainable tensor transformer 100 converts inference 150 into prediction tensor 170. In an embodiment, hand crafted logic accomplishes that conversion. For example, inference 150 may comprise a classification label, perhaps encoded as an enumeration ordinal or a label array offset, either of which may be an unsigned integer that may be converted into a scalar (i.e. zero dimensional) tensor.

Step 208 prepares output data for external integration (i.e. downstream consumption). That entails storing prediction tensor 170 and input tensors 123-124 into output tensors of respective output record 160 for input record 112. For example, that storing may be referential (i.e. shallow copy), such as when a downstream consumer resides in a same address space as trainable tensor transformer 100, such as: a) by linking and loading of a computer program, b) by redundantly mapped virtual memory shared by transformer and consumer in separate respective computer programs, or c) by distributed shared memory (DSM). If a downstream consumer does not share memory with trainable tensor transformer 100, then output record 160 may be marshalled (i.e. deep copy) into a buffer or stream for transmission to a file, a computer network, or an inter-process communication (IPC) pipe.

Example Training Configuration

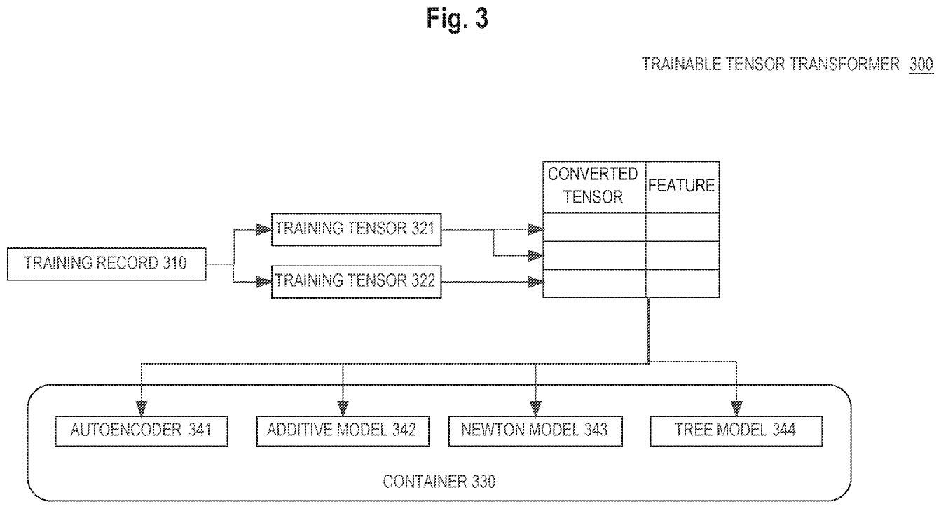

FIG. 3 is a block diagram that depicts an example trainable tensor transformer 300 in training, in an embodiment. Trainable tensor transformer 300 may be an embodiment of trainable tensor transformer 100. In an embodiment, trainable tensor transformers 100 and 300 indirectly cooperate by sharing trainable models. For example, trainable tensor transformer 300 may train and persist an ensemble of models for subsequent reloading and production use by trainable tensor transformer 100.

All or most of trainable tensor transformers 100 and 300 may be implemented by deployments of a same codebase. The codebase may contain or be extended by ensemble container 330 that may have alternate (e.g. pluggable) implementations. For example, in training, container 330 may be a training harness that may manage model training techniques such as bagging and boosting as discussed later herein. Whereas in production, container 330 may be an inference engine that may be optimized for low latency or small footprint inferencing.

Container 330 is more or less model agnostic. Container 330 may host discrepant model technologies such as models 341-344 that may operate according to very different principles and mechanisms. For example, tree model 344 may be a decision tree that learns by induction. Whereas, Newton model 343 may be exploratory by calculating and greedily climbing a gradient.

Like inferencing, in an embodiment, training may entail processing records one at a time. Parallel (e.g. batched) processing is discussed later herein. Training begins with a training corpus (not shown) consisting of more or less realistic (e.g. historic) training records such as 310 that contain or are otherwise associated with training tensors such as 321-322.

Training tensors 321-322 are more or less treated as input tensors as discussed above. Trainable tensor transformer 300 may contain a converter (not shown) that converts training tensors 321-322 into converted tensors that bear needed features as discussed above.

Trainable models 341-344 are then applied to respective subsets of converted tensors more or less as discussed above. In an embodiment, trainable models 341-344 are simultaneously applied, such as on separate hardware processing cores of a central processing unit (CPU) or on separate computers of a cluster. In an embodiment, a next training record (not shown) is not processed until all of trainable models 341-344 finish processing training record 310, which may be enforced with a synchronization barrier.

Some models may have internal parallelism and/or batching for training, such as for multiple training records at a time. Some models may be externally elastic for horizontal scaling. For example, replicas of a same model may simultaneously process separate training records, such as when the training corpus is data partitioned or batched, such as discussed later herein. In an embodiment, replicas may (e.g. periodically) share best so far (e.g. highest accuracy) learned configurations (e.g. connection weights).

Two distributed training approaches are model parallelism and data parallelism. Model parallelism has a single model that is too big to be hosted in one address space (e.g. one computer). For example, different computers may host distinct subsets of neurons of a neural network. Interconnected neurons (e.g. in different layers) may be collocated on a same computer of a cluster. For example, large connection weights indicate a high correlation of neurons, such that neurons may be distributed across a computer cluster according to connection weights, such as according to a graph partitioning algorithm that treats neurons as vertices. Because the weights change during training, occasional repartitioning of neurons (i.e. migration to other computers) may be beneficial during training.

More common is coarse grained data parallelism, which entails model replication onto multiple computers, with each replica training with a separate data partition (i.e. different subsets of training records) of the training corpus. A technique that works well with some kinds of reinforcement learning algorithms, such as neural networks, is stochastic gradient descent (SGD) for parameter space (e.g. connection weights) exploration, such as implemented by TensorFlow for training. TensorFlow's distributed SGD training partitions the training corpus into many more batches than available computers. Each iteration, a respective batch is processed by each computer. Between iterations, the computers send their results (e.g. learned gradients) to a (i.e. central) parameter server that integrates the results and broadcasts the integration results back to the computers for more accurate training on a next batch in a next iteration.

A technical problem is that only some kinds of models work with distributed SGD training. Whereas, container (i.e. training harness) 330 is parallelization agnostic. For example, second-order optimization such as Newton models such as 343, tree models such as 344, and other additive models such as 342 such as a generalized additive model (GAM) are not amenable to distributed SGD training. For example, some of trainable models 341-344 may need access to an entire training corpus and should not be trained with small batches. For such kinds of models, trainable tensor transformer 300 may maintain (e.g. cache) converted tensors for all training records of a corpus. For example, a trainable model may randomly access converted tensors of training records in any ordering, such as out of sequence, and/or subsequently revisit converted tensors of previously processed training records.

Example Training Process

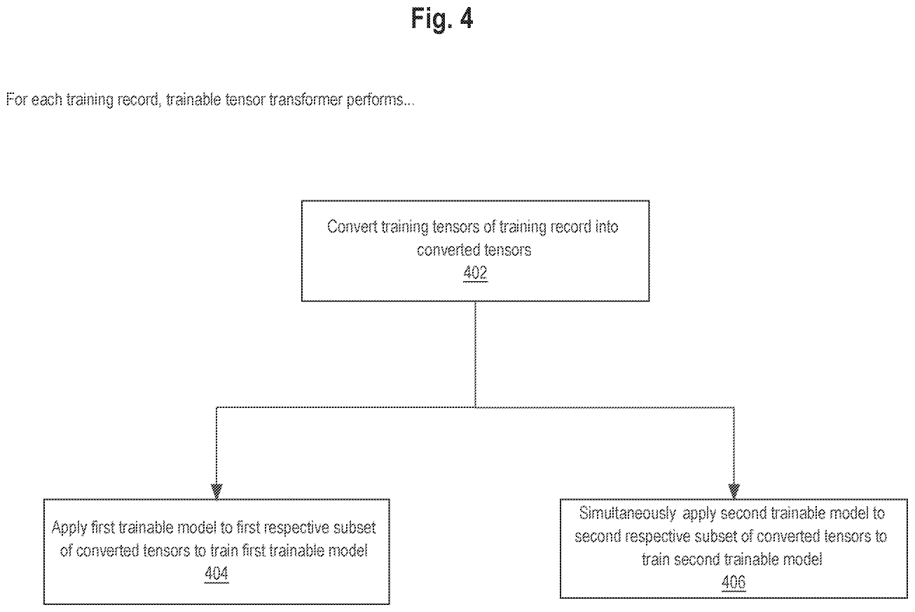

FIG. 4 is a flow diagram that depicts an example training process for a trainable tensor transformer, in an embodiment. FIG. 4 is discussed with reference to FIG. 3.

As explained above, trainable tensor transformer 300 is configured in training mode, and trainable models 341-344 are untrained. One by one, from a stream or in batches, trainable tensor transformer 300 processes training records, such as 310, of a training corpus (not shown). In step 402, trainable tensor transformer 300 extracts or obtains training tensors 321-322 directly from or indirectly through training record 310. Tensor conversion is discussed above for FIGS. 1-2.

As explained above, trainable models 341-344 may be trained in parallel. For example, each of trainable models 341-344 may be trained on its own CPU core in a same computer or on its own separate computer of a cluster. Each of steps 404 and 406 trains one respective trainable model. For example, step 404 may train Newton model 343, and step 406 may train tree model 344.

Thus, steps 404 and 406 may simultaneously occur. For example, trainable tensor transformer 300 may have an agent process (e.g. unix demon) on each computer of a cluster. The agents may await dispatch of a training job to train a respective trainable model. For example, each computer may have a backlog queue of dispatched training jobs that are still pending.

Each agent may wait until its own queue is not empty. Central dispatch software may create a training job that designates a respective model of trainable models 341-344 and then append each training job onto the queue of a respective computer. Central dispatch software may maintain a synchronization barrier that releases when all training jobs have been individually indicated as finished by their respective agents, including completion of steps 404 and 406. As discussed above, other ways of parallelism are feasible, and a same training session may be amenable to multiple (e.g. elastic and inelastic) orthogonal ways of parallelization. Thus, training of trainable tensor transformer 300 may be horizontally scaled to greatly reduce training time.

Example Transformer Topology

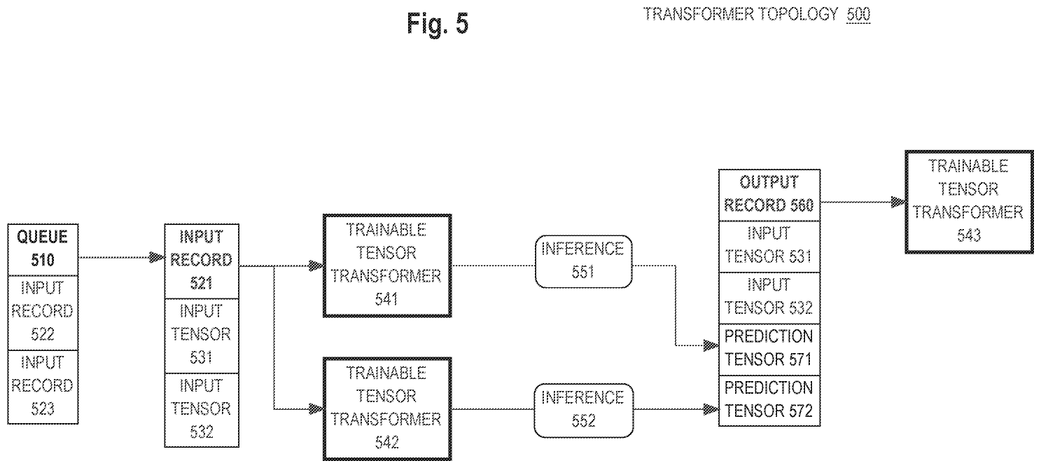

FIG. 5 is a block diagram that depicts an example transformer topology 500 that arranges cooperating trainable tensor transformers into a custom dataflow topology, in an embodiment. Transformer topology 500 has trainable tensor transformers 541-543 that were already trained and are configured for production inferencing. Some or all of trainable tensor transformers 541-543 may be implementations of production transformer 100.

Transformer topology 500 demonstrates composability of multiple trainable tensor transformers in various ways as follows. Composition of multiple transformers has several advantages, including the following three generally important advantages that leverage specialization between multiple transformers. First, analytics may be amenable to functional decomposition, such that a complex analysis may actually entail somewhat independent analytic activities, each of which may have its own dedicated (i.e. specialized) transformer. For example, facial recognition may entail eye analysis and mouth analysis, which may be separately delegated to distinct trainable tensor transformers.

Second, functional decomposition may be mandatory, such as when higher level analysis (e.g. meta-analysis) leverages lower level analysis (e.g. clustering or feature detection) that already occurred. For example, functional decomposition may be naturally amenable to a multi-stage processing pipeline, such that each stage has its own specialized trainable tensor transformer.

Third, multiple trainable tensor transformers, although slightly redundant, may achieve the benefits of a quorum at similar analysis. For example, multiple transformers may achieve an ensemble of ensembles, with integration of multiple inferences implemented by a soft max function or by another (e.g. final) trainable tensor transformer.

In this example, transformer topology 500 may be inserted into a data stream or other dataflow to process input records such as 521-523. As discussed above, each trainable tensor transformer may augment a dataflow by adding an inference, such as 551, as a prediction tensor, such as 571, into an output record, such as 560, for downstream consumption, such as by another trainable tensor transformer, such as 543. In that way, trainable tensor transformer 541 may achieve data enrichment that may be more or less incomplete, such as when further processing downstream is needed, either for further enrichment or for final analytics. Thus, transformer topology 500 may serially arrange multiple transformers 541 and 543 in sequence to achieve a multistage dataflow pipeline, such that the output of upstream transformer 541 is delivered as input to downstream transformer 543.

Likewise, multiple transformers 541-542 may be arranged in parallel and may be supplied with duplicate copies of a same stream of input records. For example, transformers 541-542 may both be independently applied to separate copies of same input record 521. Transformers 541-542 may be slightly redundant in function (although possibly containing models with very different algorithms, architectures, and/or prior training) to increase data integrity according to a quorum. Quorum semantics may entail discarding or deemphasizing (e.g. reduced weighting) some of multiple inferences 551-552 that are: a) discordant with most of inferences 551-552 (e.g. there may be more sibling transformers and inferences than shown), orb) include a low confidence metric (not shown).

Transformers 541-542 may be arranged in parallel for functional decomposition. For example, inferences 551-552 may be more or less orthogonal to each other and not necessarily redundant. For example, based on a same input image, inference 551 may classify a pair of eyes, and inference 552 may classify a mouth.

Regardless of whether inferences 551-552 are orthogonal or redundant (i.e. corroborative), both inferences may be useful downstream and may even be needed for a same downstream analysis, such as by downstream transformer 543. For example, transformer topology 500 has fan in, such that output from multiple transformers 541-542 is delivered as input to a same downstream transformer 543.

In an embodiment, fan in from upstream transformers 541-542 reuses a same output record 560 when the upstream transformers process same input record 521. In that case, separate prediction tensors 571-572 for respective inferences 551-552 from respective upstream transformers 541-542 are both stored into same output record 560. Whether multiple prediction tensors 571-572 are redundant or orthogonal may or may not be be significant to their aggregation into same output record 560 and to subsequent downstream processing.

Depending on the embodiment, transformer topology 500 may process a data stream of input records or (e.g. scheduled) batches of input records. Volume of data of a stream may fluctuate for various reasons such as naturally varying original frequency or computer network weather. In an embodiment, queue 510 buffers input records such as 522-523.

For example, either of transformer 541-542 may have insufficient processing bandwidth to absorb some spikes of incoming records. Thus, transformer topology 500 does not emit backpressure.

Queue 510 may operate as a first in first out (FIFO) that preserves the original ordering of input records 521-523. When transformers 541-542 are both ready for a next input record, such as 521, that record is removed from the head of queue 510. In an embodiment not shown, queue 510 is instead inserted between output record 560 and transformer 543. In an embodiment, queue 510 is persistent.

Transformer Cooperation

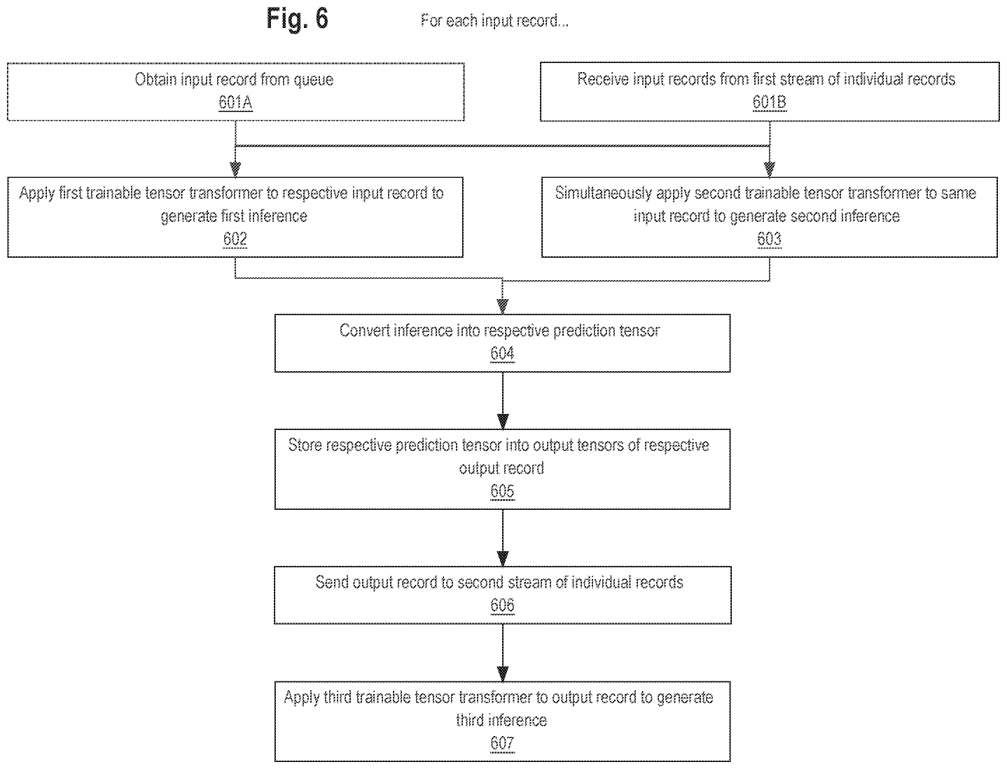

FIG. 6 is a flow diagram that depicts an example process for operating cooperating trainable tensor transformers into a custom dataflow topology, in an embodiment. FIG. 6 is discussed with reference to FIG. 5.

The steps of this process may be repeated for each of many input records. Steps 601A-B are more or less mutually exclusive implementation alternatives, such that an embodiment typically has one of steps 601A-B but not both. Steps 601A-B provide alternate ways of integrating with an upstream (e.g. original) data source that provides input records such as 521.

For example, transformer topology 500 may be inserted into a data stream of records that need augmentation or other processing. In an embodiment, transformer topology 500 is configured for more or less real time streaming, and transformer topology 500 should, in step 601B, more or less immediately begin processing each input record when it arrives in the data stream, such as with a network socket connection. That embodiment does not use and need not have queue 510.

Whereas, step 601A uses queue 510 in one of various ways, depending on the embodiment. For example, transformer topology may be intended for more or less streaming operation, but with an ability to absorb traffic spikes or otherwise mediate mismatched throughput, such as: a) when many input records more or less simultaneously arrive, b) when excessive latency of transformer topology 500 temporarily (e.g. garbage collection or virtual memory swapping) causes a backlog of pending input records, or c) when backpressure from downstream impacts throughput of transformer topology 500.

Step 601A may instead use queue 510 to intentionally accumulate a batch of input records to be processed together by transformer topology 500. For example, some processing overhead of transformer topology 500 may be amortized over many input records. For example, transformer topology 500 may have a numerically intensive trainable model(s), such as a neural network, that can be accelerated by a GPU. However, if the GPU resides on a separate card of a same shelf backplane that imposes additional handshaking, then GPU acceleration outweighs slow handshaking only when numeric processing occurs for many input records in bulk. Thus, efficiency concerns may impose a minimum batch size.

Regardless of which of steps 601A-B occurs for record ingestion, input records are still effectively processed in a same ordering as originally received. Also, regardless of which of steps 601A-B occurs, a same next input record may be processed by multiple sibling transformers, such as 541-542. Thus, transformer topology 500 may have fan out that may facilitate parallel processing to obtain multiple corroborative or orthogonal inferences without imposing additional latency.

Thus, steps 602-603 may simultaneously occur. For example, transformer 541 may perform step 602 while transformer 542 simultaneously performs step 603, such as on a separate processing core or even a separate computer.

Although shown as a single flow of data and control, steps 604-605 are repeated following each of steps 602-603. For example, transformer 541 may perform steps 604-605 while sibling transformer 542 also performs same steps 604-605.

Step 604 converts a respective inference of 551-552 into a respective prediction tensor of 571-572 as discussed above. Step 605 stores the respective prediction tensor of 571-572 into output record 560. For example, output record 560 may contain an array of output tensors, and prediction tensors 571-572 may be stored into separate offsets within the array, which may occur without cumbersome synchronization.

In an embodiment, there is a synchronization barrier between steps 605-606, such that steps 604-605 may be repeated with multiple threads, for example, whereas steps 606-607 are centralized (e.g. single threaded). The synchronization barrier releases when all of prediction tensors 571-572 have been stored into output record 560. For example, output record 560 may already be fully populated when step 606 begins.

Step 606 sends output record 560 downstream. Some or all of transformers 541-543 may be collocated on a same computer. Alternatively, there may be no collocation, and each of transformers 541-543 may reside on a separate networked computer. Sending output record 560 may entail network transmission.

If a downstream consumer, such as transformer 543, is collocated on a same computer as sibling transformers 541-542, then output record 560 may be sent through an inter-process communication (IPC) pipe. For example, sibling transformers 541-542 may be hosted by a same computer program whose standard out (stdout) is streamed to the standard input (stdin) of transformer 543. Whether distributed or collocated, sibling transformers 541-542 may be more or less decoupled from transformer 543 based on integration patterns such as a publish-subscribe (pub-sub) topic (a.k.a channel), which might entail additional middleware such as Apache Bahir for Apache Spark or Apache Ignite for Apache Spark.

In step 607, downstream transformer 543 receives and is applied to output record 560 as if it were an input record and, indeed, output record 560 contains input tensors 531-532. Thus, step 607 entails daisy chained transformers that achieve a data pipeline with transformer(s) at each stage, such as for data augmentation based on inference(s).

Example Training Topology

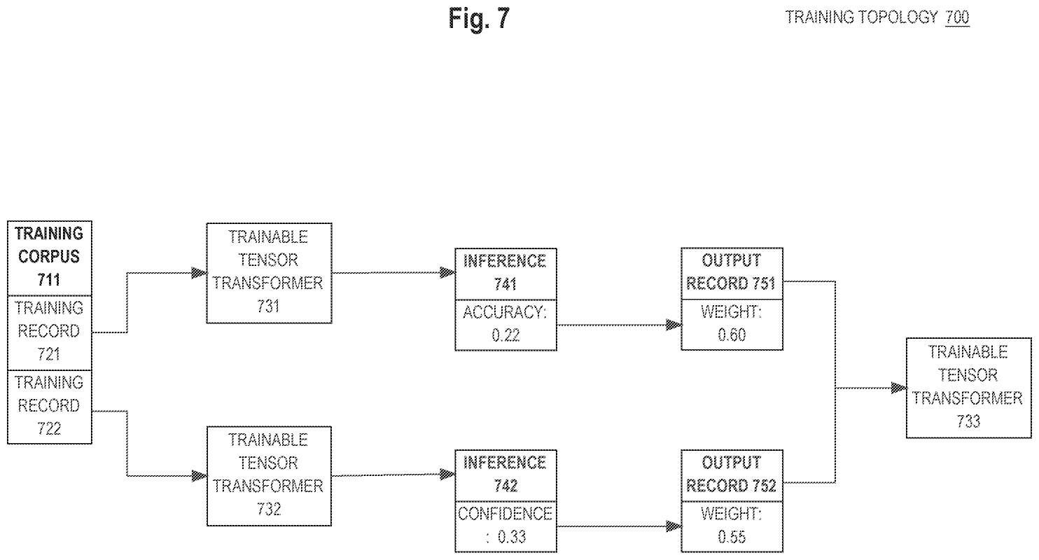

FIG. 7 is a block diagram that depicts an example training topology 700 that uses one training corpus to train multiple transformers, in an embodiment. Transformer topology 500 has trainable tensor transformers 731-733 that are undergoing (e.g. simultaneous) training. Some or all of trainable tensor transformers 731-733 may be implementations of training transformer 300.

In an embodiment not shown, sibling transformers 731-732 are each applied to all training records, such as 721-722, of training corpus 711. In the shown embodiment, accuracy of transformers 731-732 and their internal trainable models may be increased with training techniques that apply transformers 731-732 to disjoint or overlapping subsets of training corpus 711.

As shown, transformers 731-732 are not both applied to same training records. For example, transformer 731 is applied to training record 721 and not necessarily applied to training record 722. For example, sample bootstrap aggregating (bagging) may be used to train transformers 731-732, such that transformers do not share training records and instead use disjoint (i.e. non-overlapping) subsets of training records. For example, transformer 731 may train with odd numbered training records, and transformer 732 may train with even numbered training records of same training corpus 711. Even if transformers 731-732 initially have identical internal trainable models, different training data still causes differentiation between transformers 731-732. Thus, bagging may prevent overfitting that can decrease accuracy for unfamiliar samples after training.

Another training corpus technique is folded cross validation. Training may be accompanied by model accuracy testing. For example, training may cease when model accuracy converges. Training corpus 711 is partitioned into folds (i.e. subsets) of a same amount of training records 721-722.

Each of transformers 731-732 should train with a distinct subset of folds and test with a few additional fold(s). For example, two way folding entails splitting training corpus 711 into halves, and three way folding entails thirds. For example, two way folding may split training corpus 711 into odd training records and even training records. Transformer 731 may train with the odd fold and accuracy test with the even fold, and vice versa for transformer 732.

There may be more folds than transformers in training, such that training or testing subsets of folds partially overlap across the transformers in training. For example, with three way folding, there may be left, right, and center folds. Transformer 731 may train with left and right folds and test with the center fold, and transformer 732 may train with the left and center folds and test with the right fold.

Sample bagging (and folding) achieves some individuation between (e.g. otherwise similar) sibling transformers 731-732. An advantage of sample bagging is that it is non-intrusive, such that differentiation of transformers 731-732 occurs without specially and separately configuring transformers 731-732. For example, transformers 731-732 may initially be identical clones.

Another form (not shown) of bagging is feature bagging which, like sample bagging, increases individuation between sibling transformers 731-732. However, feature bagging may need transformers 731-732 to be separately configured such that transformers 731-732 isolate non- or partially overlapping subsets of features. As shown and discussed earlier with FIG. 1, each converted tensor represents a distinct feature.

As explained earlier for FIG. 1 and although not shown in FIG. 7, training record 721 contains or otherwise indicates input tensors that transformer 731 may convert into converted tensors. Also as explained and not shown in FIG. 7, transformer 731 may have various internal trainable models that may be applied to different subsets of the converted tensors. Feature bagging entails converting fewer features to generate a reduced subset of converted tensors. For example, transformer 731 may be configured to convert odd features and ignore even features, and transformer 732 can be configured vice versa, even if transformer 731-732 share a same algorithm (e.g. neural network), architecture (e.g. number of layers and/or neurons). In an embodiment, transformer 731 converts only a very few or only one feature, even when transformer 731 has many internal trainable models.

With or without feature bagging, training record 721 may bear more input tensors than transformer 731 can use. For example, as explained earlier for FIG. 1, transformer 731 should only convert a union of features needed by any of its internal trainable models. Transformer 731 may contain a tensor selector (not shown) that operates to select only needed input tensors of input record 721 and provides those selected input tensors to a tensor converter (not shown) that converts the selected input tensors into converted tensors.

Thus, the tensor selector and the tensor convertor may cooperate to distill raw input record 721 into relevant converted tensors. That includes an ability to discard or ignore many (e.g. uninteresting) features, which can minimize how much time and space are spent preparing a feature vector (not shown) of converted tensors for each internal trainable model of transformer 731. The performance benefit of such feature filtration should be substantial for feature bagging, which may ignore many or most features within any particular transformer. For example, with feature bagging, more sibling transformers may have smaller feature subsets per transformer, and thus achieve greater differentiation between transformers.

Another somewhat intrusive training technique is hypothesis boosting, which exploits variance between training records of training corpus 711. For example, training record 722 may be more interesting than training record 721 because training record 722 exemplifies an important boundary case.

As shown, sibling transformers 731-732 generate respective inferences 741-742 that are encoded into respective prediction tensors (not shown) within respective output records 751-752 that may be used to train downstream transformer 733. Transformer 733 may be configured to individually adjust the training impact (e.g. numeric weight) of each record 751-752 that transformer 733 receives. For example, transformer 733 may contain a trainable neural network model that increases or decreases connection weights during backpropagation to achieve reinforcement learning.

The magnitude of connection weight adjustments may depend on an amount of error (i.e. inaccuracy) for a current record, which may be further scaled according to the weight of the current record. For example, an average record may have a (e.g. unit normalized) weight of (e.g.) 0.5, and each record 751-752 may have its training impact scaled according to how much greater or less than 0.5 is the weight of the record. The weights of records 751-752 may cause the training impact of records 751-752 to be boosted (i.e. selectively increased) because of important boundary cases that records 751-752 embody. Boundary cases typically may be more or less extraordinary, for which transformer 733 is more less unreliable.

For example, with supervised training, inference 741 may be known to have a low accuracy, which may indicate a boundary case that should be boosted (i.e. weight increased) for emphasis during training. With unsupervised training, transformer 732 may indicate that inference 742 has a low confidence, which likewise may need boosting as a boundary case.

Training Multiple Transformers

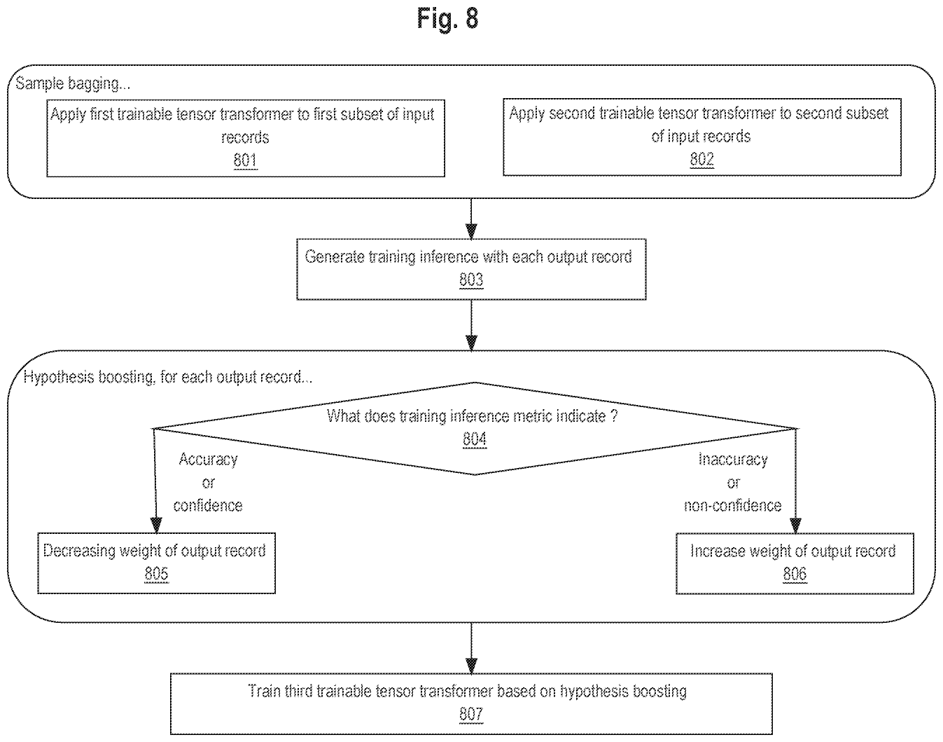

FIG. 8 is a flow diagram that depicts an example process that uses one training corpus to train multiple transformers of a training topology, in an embodiment. FIG. 8 is discussed with reference to FIG. 7.

As explained above, training topology 700 and its trainable tensor transformers 731-733 are configured for training. Sample bagging occurs during steps 801-802. In an embodiment, steps 801-802 simultaneously occur.

Sibling transformers 731-732 perform respective steps 801-802. Each of steps 801-802 trains a separate transformer by applying the transformer to a respective subset of training records, such as 721-722, of training corpus 711. In various embodiments, sibling transformers 731-732 are hosted by separate threads, CPU cores, or computers.

Step 803 occurs for each output record of each of sibling transformers 731-732. In step 803, a sibling transformer processes an input record to generate an inference, such as 741-742, and an output record, such as 751-752, that is based on the inference.

Steps 804-806 perform hypothesis boosting. Depending on the embodiment, the boosting may be performed by downstream transformer 733 or by a training harness that is inserted between transformer 733 and sibling transformers 731-732 that are upstream. Step 803 generated both an inference and a metric that assesses that inference.

In an embodiment, training of sibling transformers 731 and/or 732 is supervised, which means that training of sibling transformers 731 and/or 732 can directly detect how accurate are their inferences 741-742. For example, inference 741 may include a unit normalized accuracy that may be based on measured error.

In an embodiment, training of sibling transformers 731 and/or 732 is unsupervised. Sibling transformers 731 and/or 732 may indirectly estimate how accurate are their inferences 741-742 by instead measuring confidence. For example, inference 742 may include a unit normalized confidence that indicates a probability that inference 742 is accurate. For example, confidence may be based on activation strength of a final layer or neuron(s) of a neural network.

For boosting, each output record may be assigned a training weight that indicates relative importance of the output record. As discussed above, unusual boundary cases that challenge inferencing may be emphasized for training. Step 804 detects the relative importance of an output record for reuse as an input record at downstream transformer 733.

Step 804 examines the inference metric (e.g. accuracy or confidence) to detect relative importance of an output record. In an embodiment, step 804 uses a single threshold to categorize the value of the inference metric of each output record from sibling transformers 731-732 as either important or unimportant, where importance arises from inaccuracy or non-confidence (i.e. low accuracy or confidence) of the inference, and unimportance conversely arises from (i.e. high) accuracy or confidence. For example, an ordinary (e.g. average) inference may have an accuracy or confidence of 0.5, which may be the single threshold. Inferences 742-742 both have inference metrics below the 0.5 threshold, which indicates that output records 751-752 are both important.

In an embodiment, step 804 instead uses separate thresholds to categorize the value of the inference metric as either important or unimportant. If the inference metric value falls in between both thresholds, then the output record is neither important nor unimportant.

Depending on the outcome of step 804, either of mutually exclusive steps 805-806 may next occur. If step 804 detects that the inference metric indicates neither importance nor unimportance, then neither of steps 805-806 occur for the current inference.

As discussed above, each output record 751-752 may have a training weight that indicates relative importance for training. In an embodiment, a normalized weight of 0.5 indicates a record of normal (e.g. average) importance. Step 805 decreases the weight of unimportant (i.e. accurate or confident) records. Whereas, step 806 increases the weight of important (i.e. inaccurate or unconfident) records. In an embodiment, output records 751-752 each contain an output scalar tensor that bears a training weight as adjusted by step 805 or 806 or unadjusted.

In step 807, downstream transformer 733 receives and is trained with a next output record such as 751-752. Training of transformer 733 may entail reinforcement learning that makes (e.g. numeric) adjustment(s) to internal trainable model(s) (not shown) of transformer 733, such as by backpropagation for a neural network trainable model. Such numeric adjustments may be scaled according to the weight of the current record.

For example, both of output records 751-752 have a high weight that indicates importance. Thus, when used as training input records for downstream transformer 733, numeric model adjustments for transformer 733 should be scaled (i.e. magnified) according to the training weight of the current record. For example, when downstream transformer 733 trains with output record 751, the training impact upon transformer 733 is extraordinary because output record 751 has a high weight. Thus, training records that represent unusual boundary cases may help transformer 733 avoid overfitting (i.e. memorizing common examples at the expense of reduced accuracy for uncommon ones).

Behavioral Prediction

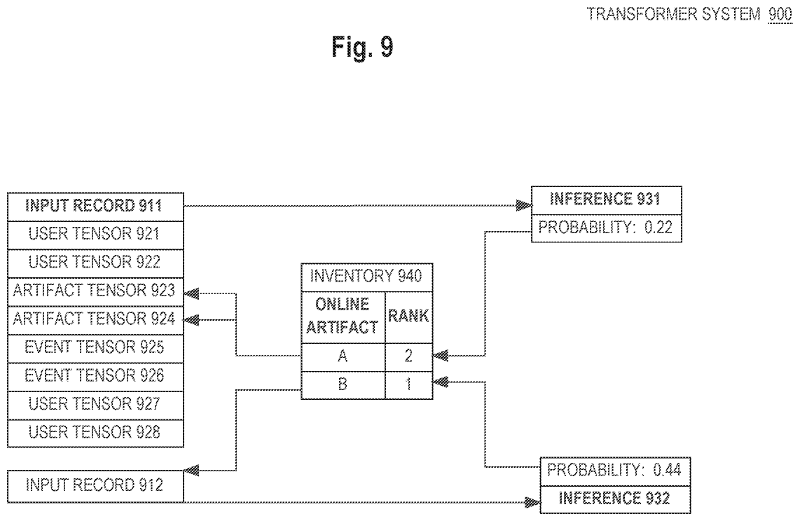

FIG. 9 is a block diagram that depicts an example transformer system 900 that can achieve personalization, generate suggestions, make matches, and/or predict behavior, in various embodiments. Although not shown, production transformer system 900 has at least one trainable tensor transformer, which may be an implementation of production transformer 100.

In operation, the transformer (not shown) is applied to input records, such as 911-912, to generate respective inferences such as 931-932. Input records 911-912 are multidimensional. For example, input record 911 may contain multiple input tensors 921-928. Further multidimensionality may arise because each input tensor 921-928 may itself be multidimensional.

Thus, data input, whether stored in an input record, input tensors, or converted tensors, may be semantically rich. For example, many converted tensors may be encoded into a flattened and (e.g. very) wide one dimensional feature vector (e.g. of numbers). Indeed, trainable tensor transformer techniques presented herein may achieve a feature vector that has much width without losing density (i.e. not sparse). Thus, single input record 911 may deliver much information for sophisticated and accurate ML inferencing. Thus, the quality and utility of inferences 931-932 may be high.

Wide records means that transformer system 900 may draw an inference not only from attributes of a single domain object, but also from a few or many domain objects. For example, at least user tensors 921-922 may represent a (e.g. human) user, such as a user profile, account, or record. Likewise, artifact tensors 923-924 may represent a (e.g. digital) artifact, such as a domain object that is available to the user, such as shown on a web page (e.g. as text or a graphic) (not shown).

Input record 911 represents multiple domain objects, which may be amenable to graph embedding (e.g. into a feature vector). For example, input record 911 as input tensors that may represent many domain objects such as an artifact, an event, and two users. In an embodiment, events may be treated as graph edges that connect graph vertices that represent users and artifacts. Thus, some or all of input tensors 921-928 may be treated together as a logical graph. In an embodiment, at least one internal trainable model of transformer system 900 may expect one or multiple features to be encoded as a logical graph. For example, some or all converted tensors may be encoded more or less as a graph embedding, such as within or instead of a feature vector for input into one or more internal trainable models.

With the ability to represent multiple domain objects, input record 911 may also represent associations, such as interactions, between domain objects. For example, event tensors 925-926 may represent an observed and recorded event, such as the display of an artifact to a user and/or a reaction by the user in response to the artifact, such as the user manipulating the artifact. For example, event tensors 925-926 may represent a mouse click, and input records 911-912 may have originally been delivered in a clickstream.

The artifact and user may entail more or less static data, and the event may entail dynamic (e.g. interactive) data. Thus, in a statistical model, such as a variance components model, static objects such as users and artifacts may be so-called fixed (a.k.a. global) effects, and events may be so-called random effects. Thus, transformer system 900 may achieve a so-called mixed model that may predict multi-object behavior.

In an embodiment, each of inferences 931-932 comprises a probability that a (same or different) user will react (e.g. directly manipulate) in some way to a (same or different) artifact. For example, input records 911-912 and inferences 931-932 may represent the respective probabilities that a same user would react to different artifacts, or that different users would react to a same artifact. In various embodiments, the online artifact may be a hyperlink and/or a web advertisement banner. In various embodiments, a user reaction may be a direct manipulation such as a hover or click of a mouse or a (e.g. interactive) scrolling of the artifact into or out of view within a viewport such as a web browser.

Thus, transformer system 900 may predict user behavior. Furthermore, behavioral predictions may reveal user preferences. For example, more clicks on car ad banners than on food ad banners may reveal that cars are preferred over food.

During training, input records 911-912 may be part of a training corpus that captures past behavior from which user preferences may be learned. With preferences learned, future behavior can be more or less accurately predicted. Some example applications of behavioral predictions are as follows.

Generally, behavioral predictions may facilitate personalization. For example, a personalization engine of an online service, such as a web service, web site, or web application, may contain transformer system 900. For example, transformer system 900 may facilitate matchmaking, where a suitable supply (e.g. artifact) is matched to demand (e.g. user).

For example, inventory 940 may catalog at least online artifacts A-B that are available to be matched with current users based on the suitability of an artifact for learned preferences of a user. For example, artifact tensors 923-924 may represent a particular search result of thousands that match a query of a particular user, and the probability for inference 931 may predict how relevant (i.e. interesting) would that particular search result be to that particular user. For example, the user may be a job seeker, the query may express the user's (e.g. salary) requirements (i.e. filter criteria), and the search result may be one of many employment opportunities such as job postings that satisfy those requirements. In another example, there need be no express query, and filter query are instead contextual, such as inferred from aspects of a current web page or a current online session.

In an embodiment, the internal trainable models of the transformer(s) of transformer system 900 learn preferences of a particular user. For example, a training corpus may contain only input records that involve the particular user. For example, each user may have a distinct respective transformer that is trained solely or primarily with the interaction history of that user.

In an embodiment, the internal trainable models of the transformer(s) of transformer system 900 learn collective preferences of some or all of a userbase of many users. For example, the transformer(s) of transformer system 900 may learn more or less normal or average preferences of a generalized user that represents multiple real users. For example, during training, transformer system 900 may learn from input records 911-912 that represent different users.

In an embodiment, user tensors 921-922 may represent a first user, and user tensors 927-928 of same input record 911 may represent a second user. For example, the first user may be a new user with little recorded history; the second user may be a familiar user with much available history; and inference 931 may represent a degree of similarity of the first and second users (e.g. their profiles or their preferences) or a probability that the second user (e.g. profile or preferences) may be a suitable proxy for the first user. For example, new users may (e.g. initially) inherit preferences of similar existing users, at least until a new user accumulates enough personal interaction history for direct preference training.

Inventory 940 may facilitate match making as follows. Generally, artifacts have varied suitability for a particular user. When suitability of an artifact is too low (e.g. falls beneath a threshold), the artifact may be suppressed (e.g. not offered to the user) or otherwise deemphasized (e.g. displayed on the periphery of a current webpage or demoted to a subsequent webpage). When suitability of an artifact is relatively high as compared to other artifacts, the artifact may be emphasized (e.g. presented in the center of a webpage or on a first result page of suitable artifacts, sorted by suitability, such as according to probability as shown in FIG. 9).

In an embodiment, transformer system 900 ranks (e.g. sorts) suitable artifacts A-B by suitability or probability. For example, a lower rank number may indicate more suitability, and a higher rank number may indicate less suitability. For example, as shown, artifact B is more suitable for the current user than artifact A is. For example, in search results, artifact B may appear before (e.g. nearer the top of a same web page than) artifact A to better suit a current user.

Conversely in an embodiment not shown, inventory 940 may rank currently active users for a particular artifact. For example, an advertiser may (e.g.) prepay to have a same ad shown once to a hundred different users during a same hour, and transformer system 900 ranks users who are currently online (e.g. browsing, connected, active session, and/or logged in) according to their preferences in relation to that ad such that the most appreciative hundred current users are selected to receive the ad. In another embodiment, transformer system 900 selects, in real time according to ranked currently active users, which current user is a best match for an ad with (e.g.) a highest unspent budget balance.

Example Prediction Process

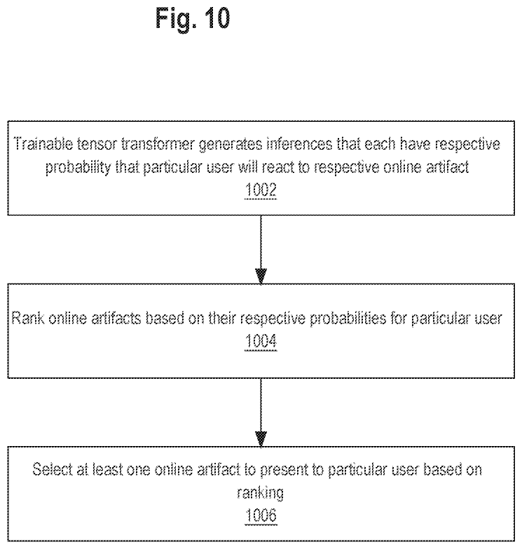

FIG. 10 is a flow diagram that depicts an example process that can achieve personalization, generate suggestions, make matches, and/or predict behavior, in various embodiments. FIG. 10 is discussed with reference to FIG. 9.

The shown steps of this process may occur in more or less rapid succession, such as when online artifacts A-B are created more or less in real time. However, inventory 940 and its userbase (not shown) may be more or less static, in which case some step(s) may be temporally isolated, so long as the shown steps are not reordered. For example, a step may occur offline (i.e. in a separate computer environment, such as with a nightly back-office automation task). Thus, some or all steps may persist their results for eventual reloading by a subsequent step.

For example, a live production environment may need to perform only last shown step(s) or even no steps. For example, each night, internet advertisements may be chosen for each user of a userbase for presentation in a banner of a website during the next day. If a user does not visit the website in the next day, then that selection processing was most likely wasted for that user. However, if the user visits in the next day, then targeted advertisement presentation for that user is accelerated because personally interesting ads were preselected.

In step 1002, a trainable tensor transformer generates inferences 931-932 that each have respective probability that a user would react to an online artifact. For example, the transformer may generate an inference for each input record, and each input record may indicate a distinct artifact for a same user, a distinct user for a same artifact, or a (e.g. arbitrary) pairing of some artifact and some user. Each inference 931-932 indicates a suitability of the artifact for the user, a probability that the user would regard the artifact as suitable, or a probability that the user would react to (e.g. manipulate) the artifact.

Step 1004 ranks multiple online artifacts A-B according to probabilities of inferences 931-932 that regard any of artifacts A-B for a particular user. In an embodiment, the ranking may be truncated to retain only a threshold amount of best (i.e. most suitable) artifacts. For example, the ranking may retain a fixed amount of (e.g. top ten) artifacts for a user, or may retain a varied amount of artifacts that exceed a suitability threshold (not shown).

Step 1006 selects artifact(s) to present to a particular user based on the ranking. For example, best advertisement(s) may be selected, or most relevant search results may be selected. If step 1006 occurs in a live production environment, then artifact selection may occur in real time.

For example, a best two ads may be selected by a web server when sending, to a user's browser, a webpage that has two places where an ad may be dynamically inserted. In another example, each artifact may be a search result, and live search results may be sorted by ranking.

If step 1006 does not occur in a live production environment, such as a nightly job instead, then step 1006 may select and persist multiple best artifacts (e.g. short list) for a particular user. The persisted selection may be periodically (e.g. scheduled job that is half hourly while that user is logged in, otherwise nightly) replaced with a new selection that is based on more recent input records, better training (e.g. corpus), or better trainable model architecture (e.g. more neural layers). Thus, ad targeting may continuously improve. Real time ad selection may reload the persisted selection to identify an ad to render on demand.

### Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

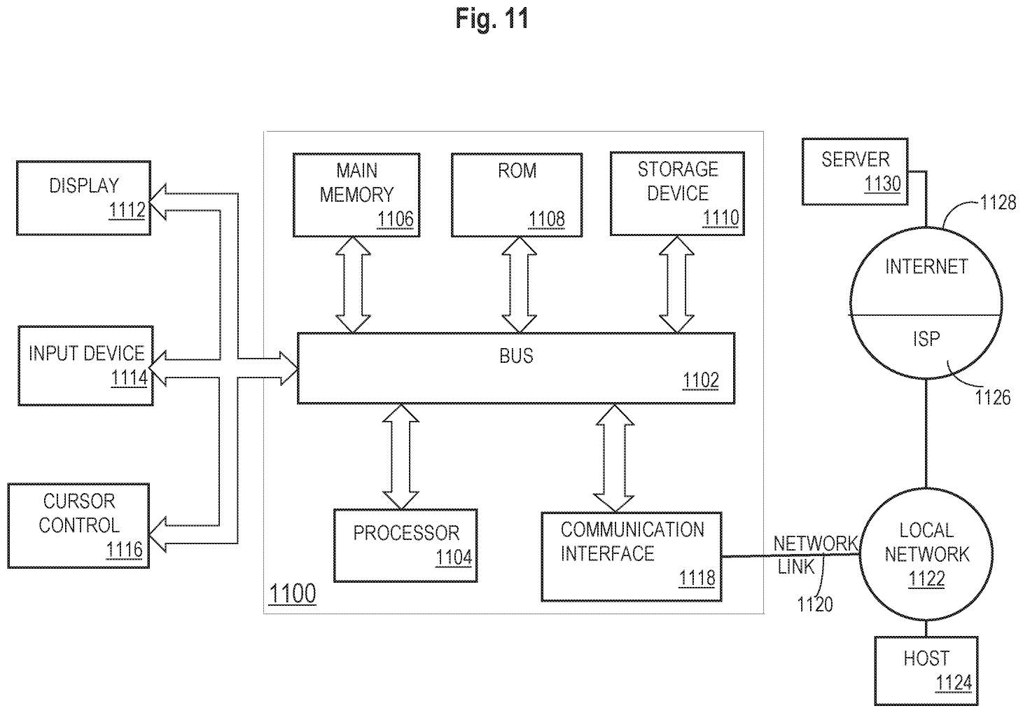

For example, FIG. 11 is a block diagram that illustrates a computer system 1100 upon which an embodiment of the present invention may be implemented. Components of the computer system 1100, including instructions for implementing the disclosed technologies in hardware, software, or a combination of hardware and software, are represented schematically in the drawings, for example as boxes and circles.

Computer system 1100 includes an input/output (I/O) subsystem 1102 which may include a bus and/or other communication mechanism(s) for communicating information and/or instructions between the components of the computer system 1100 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 1104 are coupled with I/O subsystem 1102 for processing information and instructions. Hardware processor 1104 may include, for example, a general-purpose microprocessor or microcontroller and/or a special-purpose microprocessor such as an embedded system or a graphics processing unit (GPU) or a digital signal processor.

Computer system 1100 also includes a memory 1106 such as a main memory, which is coupled to I/O subsystem 1102 for storing information and instructions to be executed by processor 1104. Memory 1106 may include volatile memory such as various forms of random-access memory (RAM) or other dynamic storage device. Memory 1106 also may be used for storing temporary variables or other intermediate information during execution of instructions to be executed by processor 1104. Such instructions, when stored in non-transitory computer-readable storage media accessible to processor 1104, render computer system 1100 into a special-purpose machine that is customized to perform the operations specified in the instructions.

Computer system 1100 further includes a non-volatile memory such as read only memory (ROM) 1108 or other static storage device coupled to I/O subsystem 1102 for storing static information and instructions for processor 1104. The ROM 1108 may include various forms of programmable ROM (PROM) such as erasable PROM (EPROM) or electrically erasable PROM (EEPROM). A persistent storage device 1110 may include various forms of non-volatile RAM (NVRAM), such as flash memory, or solid-state storage, magnetic disk or optical disk, and may be coupled to I/O subsystem 1102 for storing information and instructions.

Computer system 1100 may be coupled via I/O subsystem 1102 to one or more output devices 1112 such as a display device. Display 1112 may be embodied as, for example, a touch screen display or a light-emitting diode (LED) display or a liquid crystal display (LCD) for displaying information, such as to a computer user. Computer system 1100 may include other type(s) of output devices, such as speakers, LED indicators and haptic devices, alternatively or in addition to a display device.

One or more input devices 1114 is coupled to I/O subsystem 1102 for communicating signals, information and command selections to processor 1104. Types of input devices 1114 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1116, which may perform cursor control or other automated control functions such as navigation in a graphical interface on a display screen, alternatively or in addition to input functions. Control device 1116 may be implemented as a touchpad, a mouse, a trackball, or cursor direction keys for communicating direction information and command selections to processor 1104 and for controlling cursor movement on display 1112. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 1114 may include a combination of multiple different input devices, such as a video camera and a depth sensor.

Computer system 1100 may implement the techniques described herein using customized hard-wired logic, one or more ASICs or FPGAs, firmware and/or program logic which in combination with the computer system causes or programs computer system 1100 to operate as a special-purpose machine. According to one embodiment, the techniques herein are performed by computer system 1100 in response to processor 1104 executing one or more sequences of one or more instructions contained in memory 1106. Such instructions may be read into memory 1106 from another storage medium, such as storage device 1110. Execution of the sequences of instructions contained in memory 1106 causes processor 1104 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as memory 1106. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1100 can receive the data on the communication link and convert the data to a format that can be read by computer system 1100. For instance, a receiver such as a radio frequency antenna or an infrared detector can receive the data carried in a wireless or optical signal and appropriate circuitry can provide the data to I/O subsystem 1102 such as place the data on a bus. I/O subsystem 1102 carries the data to memory 1106, from which processor 1104 retrieves and executes the instructions. The instructions received by memory 1106 may optionally be stored on storage device 1110 either before or after execution by processor 1104.

Computer system 1100 also includes a communication interface 1118 coupled to bus 1102. Communication interface 1118 provides a two-way data communication coupling to network link(s) 1120 that are directly or indirectly connected to one or more communication networks, such as a local network 1122 or a public or private cloud on the Internet. For example, communication interface 1118 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 1118 may include a local area network (LAN) card to provide a data communication connection to a compatible LAN. Wireless links may also be implemented. In any such implementation, communication interface 1118 sends and receives electrical, electromagnetic or optical signals over signal paths that carry digital data streams representing various types of information.

Network link 1120 typically provides electrical, electromagnetic, or optical data communication directly or through one or more networks to other data devices, using, for example, cellular, Wi-Fi, or BLUETOOTH technology. For example, network link 1120 may provide a connection through a local network 1122 to a host computer 1124 or to other computing devices, such as personal computing devices or Internet of Things (IoT) devices and/or data equipment operated by an Internet Service Provider (ISP) 1126. ISP 1126 provides data communication services through the world-wide packet data communication network commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data and instructions, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage device 1110, or other non-volatile storage for later execution.

General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising for each input record of a plurality of input records, a trainable tensor transformer performing:
converting a plurality of input tensors of the input record into a plurality of converted tensors, wherein each tensor of the plurality of converted tensors represents a respective feature of a plurality of features that are capable of being processed by a plurality of trainable models;
applying the plurality of trainable models to the plurality of converted tensors to generate an inference for the input record;
converting the inference into a prediction tensor;
storing the prediction tensor and the plurality of input tensors into a plurality of output tensors of a respective output record for the input record.

2. The method of claim 1 further comprising:
converting, by a trainable tensor transformer, for each training record of a plurality of training records, a plurality of training tensors of the training record into a second plurality of converted tensors, wherein each converted tensor of the second plurality of converted tensors represents a respective feature of the plurality of features;
applying, by the trainable tensor transformer, the plurality of trainable models to the second plurality of converted tensors to train the plurality of trainable models.

3. The method of claim 2 wherein said train the plurality of trainable models comprises simultaneously applying at least two trainable models of the plurality of trainable models.

4. The method of claim 2 wherein the plurality of trainable models comprises a decision tree, a second-order optimization, an additive model, or an autoencoder.

5. The method of claim 1 wherein said converting the plurality of input tensors comprises:
associating each trainable model of the plurality of trainable models with respective one or more converted tensors of the plurality of converted tensors;
associating each tensor of the plurality of converted tensors with respective one or more input tensors of the plurality of input tensors;
generating the plurality of converted tensors based on said associating each trainable model and said associating each tensor.

6. The method of claim 1 wherein said converting the plurality of input tensors of the input record into the plurality of converted tensors comprises obtaining the input record from a queue.

7. The method of claim 1 further comprising applying a second trainable tensor transformer to each respective output record.

8. The method of claim 7 further comprising:
training, by the trainable tensor transformer, the plurality of trainable models with a plurality of training records to generate a training inference with each output record of a plurality of output records;
hypothesis boosting by, for each output record of the plurality of output records:
increasing a weight of the output record when the training inference comprises a metric that indicates inaccuracy or nonconfidence of the training inference, and
decreasing the weight of the output record when said metric indicates accuracy or confidence of the training inference;
training the second trainable tensor transformer based on said hypothesis boosting.

9. The method of claim 1 further comprising:
applying a second trainable tensor transformer to the plurality of input records to generate a second inference;
converting, by the second trainable tensor transformer, the second inference into a second prediction tensor;
storing, by the second trainable tensor transformer, the second prediction tensor into said plurality of output tensors of said respective output record.

10. The method of claim 9 wherein said applying the second trainable tensor transformer to the plurality of input records comprises applying the second trainable tensor transformer to a subset of the plurality of input records that is based on sample bootstrap aggregating (bagging).

11. The method of claim 9 wherein the inference and the second inference are simultaneously generated.

12. The method of claim 1 wherein:
said converting the plurality of input tensors comprises receiving the plurality of input records from a first stream of individual records;
said storing into the plurality of output tensors of said respective output record comprises sending each said respective output record to a second stream of individual records.

13. The method of claim 1 wherein the inference comprises a probability that a particular user will manipulate a particular online artifact.

14. The method of claim 13 wherein the particular online artifact comprises a hyperlink or an advertisement banner.

15. The method of claim 13 further comprising:
generating, by the trainable tensor transformer, a plurality of inferences, wherein each inference of the plurality of inferences comprises a respective probability that the particular user will manipulate a respective online artifact of a plurality of online artifacts;
ranking the plurality of online artifacts based on their respective probabilities;
selecting at least one online artifact of the plurality of online artifacts to present to the particular user based on said ranking.

16. The method of claim 1 wherein the inference comprises a probability that a particular search result or a particular employment opportunity is suited for a particular user.

17. The method of claim 1 wherein:
the inference represents a probability that a generalized user would manipulate a particular online artifact,
the generalized user is based on multiple users.

18. The method of claim 1 wherein the plurality of input tensors comprises:
one or more user tensors that represent at least one user,
one or more artifact tensors that represent at least one online artifact, and/or
one or more event tensors that represent at least one event that occurred between a user and an artifact.

19. The method of claim 1 wherein:
the plurality of input tensors comprises:
a first one or more tensors that represent a first user and/or events that involved the first user, and
a second one or more tensors that represent a second user and/or events that involved the second user;
the inference represents a probability that the first user is similar to the second user or that preferences of the first user are similar to preferences of the second user.

20. One or more non-transitory computer-readable media storing instructions that, when executed by one or more computers, cause for each input record of a plurality of input records, a trainable tensor transformer performing:
converting a plurality of input tensors of the input record into a plurality of converted tensors, wherein each tensor of the plurality of converted tensors represents a respective feature of a plurality of features that are capable of being processed by a plurality of trainable models;
applying the plurality of trainable models to the plurality of converted tensors to generate an inference for the input record;
converting the inference into a prediction tensor;
storing the prediction tensor and the plurality of input tensors into a plurality of output tensors of a respective output record for the input record.
